(19) United States
(12) Patent Application Publication
(10) Pub. No.: US 2013/0265210 A1
(43) Pub. Date: Oct. 10, 2013

(54) INFORMATION PROCESSING TERMINAL AND CONTROL METHOD THEREOF

(71) Applicant: Kotaro Honda, Tokyo (JP)

(72) Inventor: Kotaro Honda, Tokyo (JP)

(73) Assignee: NEC CORPORATION, Tokyo (JP)

(21) Appl. No.: 13/992,933

(22) PCT Filed: Dec. 18, 2011
(86) PCT No.: PCT/JP2011/078415

§ 371 Date: Jun. 10, 2013

(30) Foreign Application Priority Data
May 1, 2011 (JP) 2011-000831

(51) Int. Cl. G06F 3/14

(52) U.S. Cl. CPC G06F 3/1423
USPC 345/1.1

(57) ABSTRACT

An information processing terminal includes a display unit and a control unit. The display unit includes a plurality of displays. The control unit can display screens on the displays in a plurality of display modes in which display forms on the displays are different. The control unit displays a display mode change-over switch within the screens. When the display mode change-over switch is designated, the control unit displays a list of only those display modes to which a current display mode can be changed so that each display mode can be designated. Further, the control unit displays, when one display mode is designated, the screens in the designated display mode.

### TECHNICAL FIELD

The present invention relates to an information processing terminal that includes a plurality of touch panel displays.

### BACKGROUND ART

Information processing terminals such as a mobile telephone, a smartphone, a mobile information terminal, or a personal computer includes a type that includes two displays. Many information processing terminals include browsers, and accordingly can browse web pages on a network such as the Internet.

To compensate for the disadvantage of the mobile information processing terminal having a small screen, there has been offered a browser function or an operation suited to a mobile information processing terminal (refer to Patent Literature 1). The technology disclosed in Patent Literature 1 is for improving convenience for opening a new web page or for returning to an original web page. The mobile information terminal disclosed in Patent Literature 1 acquires link destination page information of a web page to lay it out on a virtual screen, and displays a part of the information on a temporary window opened near a link object, thereby facilitating transfer to the link destination.

### CITATION LIST

Patent Literature 1: JP2010-237776A

### SUMMARY OF INVENTION

### Problems to be Solved

However, the technology disclosed in Patent Literature 1 does not take into account an information processing terminal that includes a plurality of displays. Consequently, a plurality of displays has not been effectively used.

It is therefore an object of the present invention to provide a technology capable of achieving high ease of use at time when displaying screen in the information processing terminal that includes the plurality of displays.

### Solution to Problem

To achieve the object, an information processing terminal according to the present invention includes:

a display unit having a plurality of displays; and

a control unit that can display screens on the displays in a plurality of display modes in which display forms on the displays are different, that displays a display mode change-over switch within the screens, that displays, when the display mode change-over switch is designated, a list of only those display modes to which a current display mode can be changed so that each display mode can be designated, and that displays, when one display mode is designated, the screens in the designated display mode.

According to the present invention, there is provided a control method for an information processing terminal that includes a plurality of displays and that is capable of displaying screens on the displays in a plurality of display modes in which display forms on the displays are different. The method includes:

displaying a display mode change-over switch within the screens;

displaying, when the display mode change-over switch is designated, a list of only those display modes to which a current display mode can be changed so that each display mode can be designated; and

displaying, when one display mode is designated, the screens in the designated display mode.

### Effects of Invention

According to the present invention, high ease of use at time when displaying screen can be achieved in the information processing terminal that includes the plurality of displays.

### BRIEF DESCRIPTION OF DRAWINGS

FIG. 1 is a front view showing an information processing terminal according to the present exemplary embodiment.

FIG. 2 is a block diagram showing the functional configuration of the information processing terminal according to the present exemplary embodiment.

FIG. 3 is a view showing an example of displaying of a one-screen display mode.

FIG. 4 is a view showing an example of displaying of a two-screen display mode.

FIG. 5 is a view showing another example of displaying of the two-screen display mode.

FIG. 6 is a view showing an example of displaying of a full-screen display mode.

FIG. 7 is a view showing an example of displaying when display mode change-over switch 25 is touched.

FIG. 8 is a view showing an example of a setting screen for performing various setting operations by user's selection.

### DESCRIPTION OF EMBODIMENTS

The exemplary embodiments of the present invention will be described in detail with reference to the drawings.

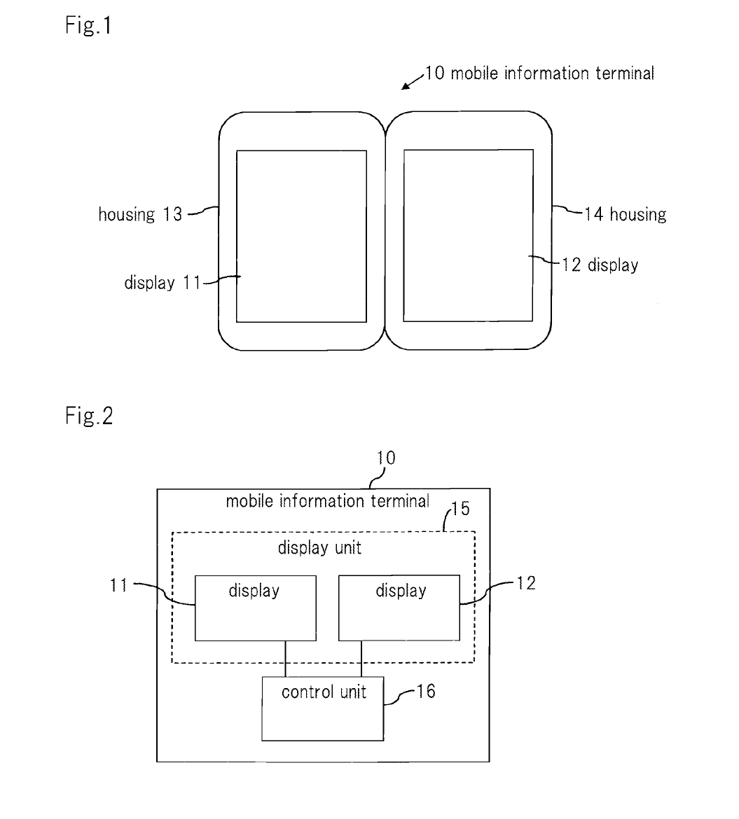

FIG. 1 is a front view showing an information processing terminal according to the present exemplary embodiment. Information processing terminal 10 according to the present exemplary embodiment is an example of a mobile information terminal that has a communication function, and includes two housings 13 and 14 connected to each other to be openable and closable, and housings 13 and 14 have displays 11 and 12 respectively. Two displays 11 and 12 are arranged so that display surfaces can be directed in the same direction in opened states of housings 13 and 14 so that both displays simultaneously come within the user's field of view.

FIG. 2 is a block diagram showing the functional configuration of the information processing terminal according to the present exemplary embodiment. Referring to FIG. 2, information processing terminal 10 includes display unit 15 and control unit 16. Display unit 15 includes displays 11 and 12.

Each of displays 11 and 12 is a touch panel display input device that has a function of displaying on the screen and a function of detecting a touching operation performed by user's finger or pen. Each of displays 11 and 12 displays the screen under the control of control unit 16, and notifies control unit 16 of touch input information indicating a position touched by the user.

Control unit 16 executes processing according to instructions given from the user by operating displays 11 and 12, and displays screens on displays 11 and 12 corresponding to the processing. To take the example of a browser, control unit 106 has a browser function, and displays browser screens such as web pages on displays 11 and 12 according to the operations on displays 11 and 12.

Concerning the display forms of the browser screens on displays 11 and 12, there is a plurality of display modes, namely, a one-screen display mode, a full-screen display mode, and a two-screen display mode.

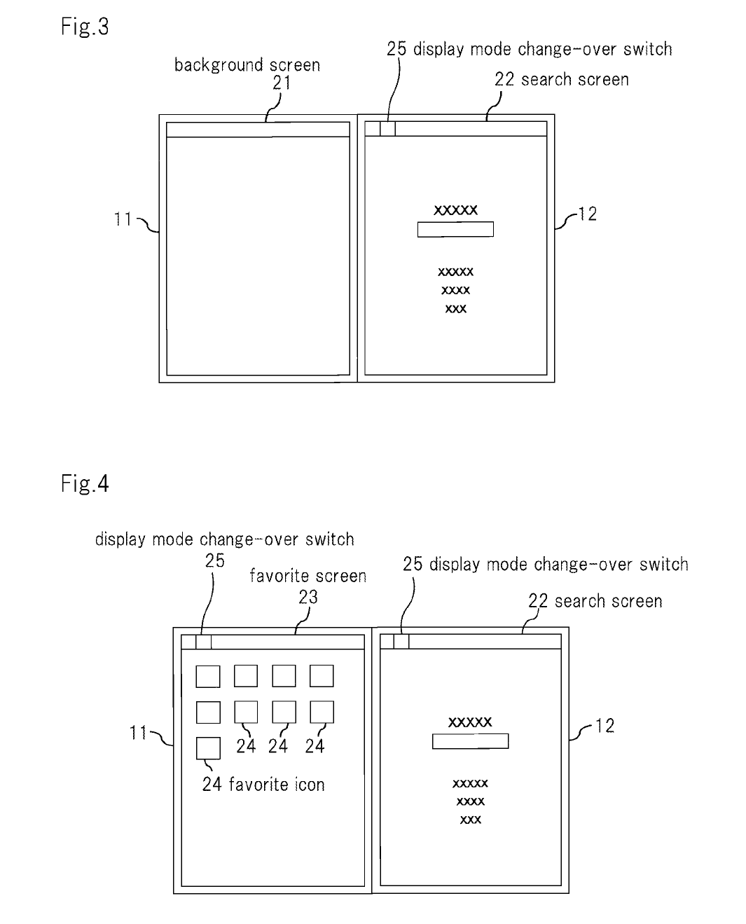

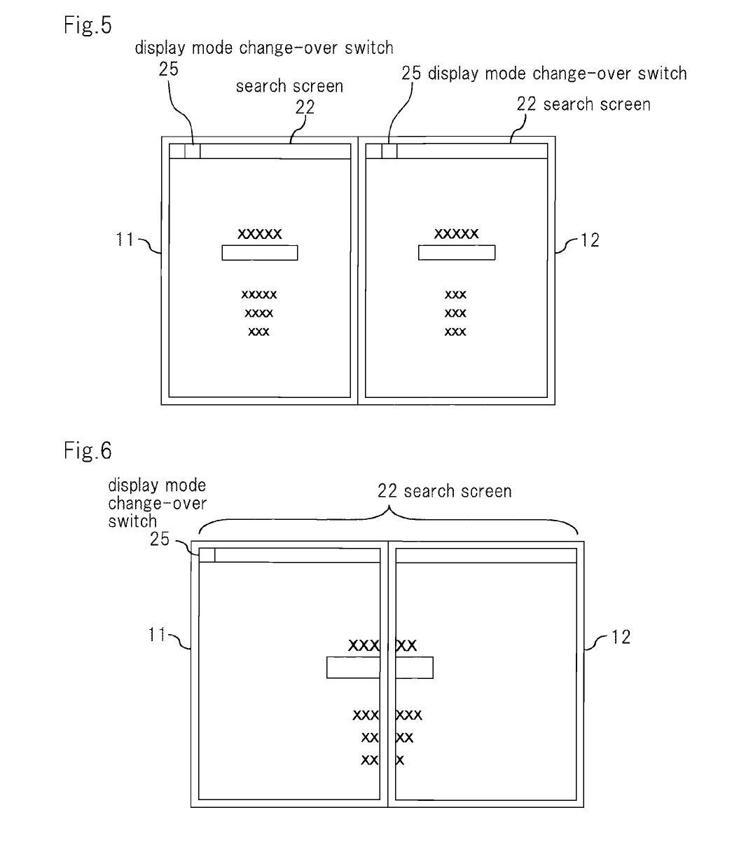

FIG. 3 shows an example of displaying of the one-screen display mode, FIG. 4 shows an example of displaying of the two-screen display mode, FIG. 5 shows another example of displaying of the two-screen display mode, and FIG. 6 shows an example of displaying of the full-screen display mode. In FIGS. 3 to 6, the displaying of display 11 is shown on the left side, and the displaying of display 12 is shown on the right side.

The one-screen display mode is a mode for displaying the browser screen on one of the displays. In the example of the one-screen display mode shown in FIG. 3, search screen 22 is displayed on right display 12, and background screen 21 is displayed as an example of a screen other than the browser screen on left display 11. Search screen 22 is a type of a browser screen. Search screen 22 shown in FIG. 3 includes display mode change-over switch 25 in a tool bar. Display mode change-over switch 25 is a switch for switching display modes of the browser screen. When the user touches display mode change-over switch 25, a pull-down menu, that lists up only those display modes to which a current display mode can be changed is displayed. When the user touches one of the display modes listed on the pull-down menu, displaying of the browser screen is switched to displaying of the touched display mode.

The two-screen display mode is a mode for displaying the different browser screens on displays 11 and 12. The two-screen display mode further includes two display modes.

The first two-screen display mode is a mode for displaying a screen such as a web page screen or a search screen on one display, and for displaying a screen including a favorite icon on the other display. In the example of the first two-screen display mode shown in FIG. 4, favorite screen 23 including favorite icon 24 for designating a favorite web page is displayed on display 11, and search screen 22 is displayed on display 12. Favorite screen 23 is also a type of a browser screen.

The second two-screen display mode is a mode for displaying different web page screens or search screens on both displays. In the example of the second two-screen display mode shown in FIG. 5, search screens 22 are respectively displayed on display 11 and display 12.

Favorite screen 23 shown in FIG. 4 and search screens 22 shown in FIGS. 4 and 5 include display mode change-over switches 25 in the tool bar.

The full-screen display mode is a mode for displaying one browser screen on displays 11 and 12. In the example of the full-screen display mode shown in FIG. 6, one search screen 22 is displayed on displays 11 and 12. Search screen 22 shown in FIG. 6 includes display mode change-over switch 25 in the tool bar.

As described above, control unit 16 displays display mode change-over switch 25 in the tool bar. When display mode change-over switch 25 is touched, control unit 106 displays display modes to which the current display mode can be changed so that they can be designated. Specifically, when display mode change-over switch 25 is touched, control unit 106 displays a list of only those display modes to which the current display mode can be changed by pulling-down. Since there is no need to perform any operation for transferring to the current display mode from the current display mode, the current display mode is deleted from the list of the display modes.

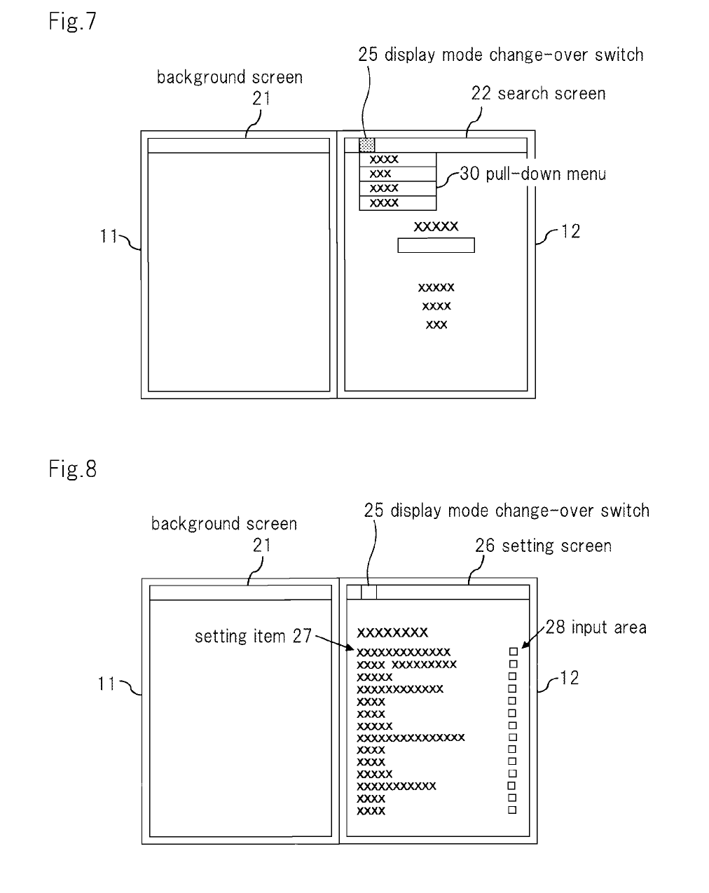

FIG. 7 shows an example of displaying when display mode change-over switch 25 is displayed. Referring to FIG. 7, pull-down menu 30, that lists up only those display modes to which the current display mode can be changed is displayed. In pull-down menu 30, the display modes to which the current display mode can be changed are vertically arranged under touched display mode change-over switch 25. When the user touches one of the listed-up display modes of pull-down menu 30, the browser screen is switched to the display mode.

Control unit 16 inhibits displaying of a specific display mode depending on the type of the browser screen. When display mode change-over switch 25 of the browser screen where the specific display mode is inhibited is designated, control unit 16 displays display modes other than the specific display mode so that they can be designated in pull-down menu 30.

For example, concerning a set of the browser screen where left-aligned displaying and right-aligned displaying are performed on the same row, control unit 16 inhibits displaying of the full-screen display mode. This is for preventing the displaying of the full-screen display mode from excessively increasing the space between the left-aligned displaying and the right-aligned displaying. For example, in an example shown in FIG. 8, on setting screen 26 where various setting operations for an OS (operating system) are performed according to the user's selection, setting item 27 is left-aligned displayed, and input area 28 of a check box for setting item 27 is right-aligned displayed. When setting screen 26 is displayed in the full-screen display mode, it is difficult to use setting item 27 and input area 28 because they are far from each other. Concerning such a type of browser screen, it is advisable to inhibit the full-screen display mode.

Control unit 106 can inhibit or permit transfer from the one-screen display mode to the second two-screen display mode. When it inhibits the transfer from the one-screen display mode to the second two-screen display mode, control unit 106 does not include the second two-screen display mode in pull-down menu 30 of the browser screen displayed in the one-screen display mode. When it permits the transfer from the one-screen display mode to the second two-screen display mode, control unit 106 can display, as a new browser screen to be displayed as instructed, the browser screen of a web page set as a home page displayed at the time that browser is activated.

As described above, according to the present exemplary embodiment, the display modes to which the current display mode can be changed are listed up and displayed to be specifiable. Thus, in information processing terminal 10 that enables various display modes effectively using displays 11 and 12, the user can easily and quickly switch a mode to the desired display mode.

According to the present exemplary embodiment, only the display modes to which the current display mode can be changed are listed up and displayed. Thus, the user can easily understand the display modes to which the current display mode can be changed, and can switch the display modes by moving his/her finger a short distance.

According to the present exemplary embodiment, a display mode in which it is difficult for the user to view the display or in which it is difficult for the user to operate the display is prevented depending on the type of the browser screen. Thus, the user can easily select a display mode in which it is easy for the user to view the display or in which it is easy for the user to operate the display.

According to the present exemplary embodiment, information processing terminal 10 includes two displays 11 and 12. However, the present invention is not limited to this configuration. As another exemplary embodiment, information processing terminal 10 can include three or more displays. In such a case, there is no difference in basic processing of control unit 16, that is, when display mode change-over switch 25 is designated within the browser screen, the display modes to which the current display mode can be changed are displayed so that they can be designated and, when one display mode is designated, the browser screen is displayed in the designated display mode.

The exemplary embodiments of the present inventions have been described. However, the present invention is not limited to these exemplary embodiments. These exemplary embodiments can be combined or partially changed within the scope of the technical ideas of the present invention.

This application claims priority from Japanese Patent Application No. 2011-000831 filed Jan. 5, 2011, which is hereby incorporated by reference herein in its entirety.

1. An information processing terminal comprising:
a display unit having a plurality of displays; and
a control unit that can display screens on the displays in a plurality of display modes in which display forms on the displays are different, that displays a display mode change-over switch within the screens, that displays, when the display mode change-over switch is designated, a list of only those display modes to which a current display mode can be changed so that each display mode can be designated, and that displays, when one display mode is designated, the screens in the designated display mode.

2. The information processing terminal according to claim 1, wherein:
the number of displays of the display unit is two; and
the display modes include a one-screen display mode of displaying a screen on one of the displays, a full-screen display mode of displaying one screen on the two displays, and a two-screen display mode of displaying a screen on each of the two displays.

3. The information processing terminal according to claim 1, wherein the control unit inhibits displaying of the full-screen display mode on a screen where a set of left-aligned displaying and right-aligned displaying are performed on the same row.

4. The information processing terminal according to claim 1, wherein the control unit displays the display mode change-over switch on a tool bar of the screen.

5. A control method for an information processing terminal that includes a plurality of displays and that is capable of displaying screens on the displays in a plurality of display modes in which display forms on the displays are different,
the method including:
displaying a display mode change-over switch within the screens;
displaying, when the display mode change-over switch is designated, a list of only those display modes to which a current display mode can be changed so that each display mode can be designated; and
displaying, when one display mode is designated, the screens in the designated display mode.

6. The control method for the information processing terminal according to claim 5, wherein:
the number of displays is two; and
the display modes include a one-screen display mode of displaying a screen on one of the displays, a full-screen display mode of displaying one screen on the two displays, and a two-screen display mode of displaying a screen on each of the two displays.
